(19) United States
(12) Patent Application Publication
(10) Pub. No.: US 2008/0072794 A1
(43) Pub. Date: Mar. 27, 2008

(54) Reactive Silicon Suboxide Flakes

(76) Inventors: Holger Hoppe, Lorrach (DE); Patrice Bujard, Courtepin (CH); Holger Leybach, Maulburg (DE); Hans Reichert, Rheinfelden (DE)

Correspondence Address: JoAnn Villamizar;Ciba Corporation/Patent Department, 540 White Plains Road, P.O. Box 2005, Tarrytown, NY, 10591, US

(21) Appl. No.: 11/632,685

(22) PCT Filed: Jul. 18, 2005
(86) PCT No.: PCT/EP05/53428

§ 371 Date: Jan. 17, 2007

(30) Foreign Application Priority Data
Jul. 26, 2004 (EP) 04103565.0

(51) Int. Cl. C01B 33/12; C04B 14/02

(52) U.S. Cl. 106/482; 423/325

(57) ABSTRACT

The present invention is directed to SiO_{y} flakes with 0.70≦y≦1.95, especially 0.70≦y≦1.80, very especially 1.0≦y≦1.8, comprising reactive centres, a process for their production, and their use for providing chemically modified SiO_{y} flakes.

The present invention is directed to SiO_{y} flakes with 0.70≦y≦1.95, especially 0.70≦y≦1.80, very especially 1.0≦y≦1.8, comprising reactive centres, a process for their production, and their use for providing chemically modified SiO_{y} flakes.

WO03/068868 (and WO03/106569) describes a process for the production of SiO_{Z} flakes (0.95≦y≦1.8): NaCl, followed successively by a layer of silicon suboxide (SiO_{y}) are vapor-deposited onto a carrier, which may be a continuous metal belt, passing by way of the vaporisers under a vacuum of <0.5 Pa. The interference pigments described in WO03/068868 can advantageously be combined with conventional transparent organic pigments, such as, for example diketopyrrolopyrroles.

According to WO04/065295 porous SiO_{Z} flakes are produced in the following manner: NaCl, followed successively by a layer of silicon suboxide (SiO_{y}) and NaCl, are vapor-deposited onto a carrier, which may be a continuous metal belt, passing by way of the vaporisers under a vacuum of <0.5 Pa.

The mixed layer of silicon suboxide (SiO_{y}) and NaCl is vapor-deposited by two distinct vaporizers, wherein the separating agent is contained in the mixed layer in an amount of 1 to 60% by weight based on the total weight of the mixed layer.

The thicknesses of NaCl vapor-deposited are about 20 nm to 100 nm, especially 30 to 60 nm, those of the mixed layer from 20 to 2000 nm, especially 50 to 500 nm depending upon the intended characteristics of the product.

The carrier is immersed in water. With mechanical assistance, the NaCl rapidly dissolves in water and the product layer breaks up into flakes, which are then present in water in the form of a suspension. The disadvantage of the above described process may be that the reactive centres of the porous silicon oxide flakes are deactivated by the action of water.

Said disadvantage can be avoided by using a separating agent which is soluble in a solvent which does not react with the reactive centres of the silicon oxide flakes. Preferably, the separating agent is an organic separating agent, which is soluble in an inert organic solvent.

Accordingly, the present invention is directed to SiO_{y} flakes with 0.70≦y≦1.95, especially 0.70≦y≦1.80, very especially 1.0≦y≦1.8, comprising reactive centres.

The term “reactive centre” means, that at least one Si—Si group, preferably Si—Si groups, i.e. [SiO₄₋ₓSiₓ] components (x≧1), especially [SiSi₄] components are present in the SiO_{y} flakes.

By using an organic separating agent and an inert solvent the following products are available:

a) SiO_{y} flakes having reactive centres on their surface,

b) porous SiO_{y} flakes having reactive centres on their surface and in their pores, as well as

c) porous SiO_{y} flakes having only reactive centres in their pores.

According to solid state ²⁹Si—NMR spectroscopy the SiO_{y} flakes show besides the signal at ca. −110 ppm, which is typical for [SiO₄] components a significant signal at ca. −85 ppm, which is typical for [SiSi₄] components. In addition, the SiO_{y} flakes can show an additional signal at ca. −73 ppm, which is typical for [SiO₄₋ₓSiₓ] components (x≧1). The SiO_{y} flakes are clearly distinguished from commercially available SiO (for example Patinal®, Merck). According to solid state ²⁹Si—NMR spectroscopy Patinal® shows besides the signal at ca. −110 ppm a signal at −69 ppm, which is allocated to [SiO₄₋ₓSiₓ] components.

Accordingly, the term reactive centre means, that [SiSi₄] components are present in the SiO_{y} flakes. It is assumed, that phase separated SiO is present, wherein very small Si components are embedded in a SiO₂ matrix.

The term “SiO_{y} with 0.70≦y≦1.95” means that the molar ratio of oxygen to silicon at the average value of the silicon oxide substrate is from 0.70 to 1.95. The composition of the silicon oxide substrate can be determined by ESCA (electron spectroscopy for chemical analysis). The stoichiometry of silicon and oxygen of the silicon oxide substrate can be determined by RBS (Rutherford-Backscattering).

The plate-like (plane-parallel) SiO_{y} structures (SiO_{y} flakes), especially porous SiO_{y} flakes used according to the present invention have a length of from 1 μm to 5 mm, a width of from 1 μm to 2 mm, and a thickness of from 20 nm to 1.5 μm, and a ratio of length to thickness of at least 2:1, the particles having two substantially parallel faces, the distance between which is the shortest axis of the particles (thickness). The porous SiO_{y} flakes are mesoporous materials, i.e. have pore widths of ca. 1 to ca. 50 nm, especially 2 to 20 nm. The pores are randomly inter-connected in a three-dimensional way. So, when used as a support, the passage blockage, which frequently occurs in SiO₂ flakes having a two-dimensional arrangement of pores can be prevented. The specific surface area of the porous SiO_{y} flakes depends on the porosity and ranges from ca. 400 m²/g to more than 1000 m²/g. Preferably, the porous SiO_{y} flakes have a specific surface area of greater than 500 m²/g, especially greater than 600 m²/g. The BET specific surface area is determined according to DIN 66131 or DIN 66132 (R. Haul und G. Dümbgen, Chem.-Ing.-Techn. 32 (1960) 349 and 35 (1063) 586) using the Brunauer-Emmet-Teller method (J. Am. Chem. Soc. 60 (1938) 309).

The SiO_{y} flakes, especially porous SiO_{y} flakes are not of a uniform shape. Nevertheless, for purposes of brevity, the flakes will be referred to as having a “diameter.” The SiO_{Z} flakes have a plane-parallelism and a defined thickness in the range of ±10%, especially ±5% of the average thickness. The SiO_{y} flakes have a thickness of from 20 to 2000 nm, especially from 100 to 500 nm. It is presently preferred that the diameter of the flakes is in a preferred range of about 1-60 μm with a more preferred range of about 5-40 μm and a most preferred range of about 5-20 μm. Thus, the aspect ratio of the flakes of the present invention is in a preferred range of about 2.5 to 625 with a more preferred range of about 50 to 250.

The processes for the production of

a) SiO_{y} flakes having reactive centres on their surface,

b) porous SiO_{y} flakes having reactive centres on their surface and in their pores, as well as

c) porous SiO_{y} flakes having only reactive centres in their pores is described in more detail below:

Variant a)

The SiO_{y} flakes having reactive centres on their surface are obtainable by a process comprising the steps of:

a) vapor-deposition of an organic separating agent onto a carrier to produce a separating agent layer,

b) the vapor-deposition of SiO_{y} onto the separating agent layer (a),

c) the separation of SiO_{y} from the separating agent, wherein 0.70≦y≦1.80, by dissolution in an inert organic solvent.

Variant b)

The porous SiO_{y} flakes having reactive centres on their surface and in their pores are obtainable by a process comprising the steps of:

a) vapor-deposition of an organic separating agent onto a carrier to produce a separating agent layer,

b) the simultaneous vapor-deposition of SiO_{y} and the organic separating agent onto the separating agent layer (a),

c) the separation of SiO_{y} from the organic separating agent, wherein 0.70≦y≦1.95, by dissolution in an inert organic solvent.

In an alternative of variants a) and b) a separating agent (first separating agent), which is dissolvable in water, is deposited on the carrier before step a) and is dissolved in water before step c). Said alternative has the advantage that the flakes encapsulated in the organic separating agent (second separating agent) can be isolated by dissolving the first separating agent in water. For the separation of the second separating agent the isolated flakes can be treated in an inert organic solvent subsequently.

Variant c)

The porous SiO_{y} flakes having reactive centres only in their pores are obtainable by a process comprising the steps of:

a) vapor-deposition of a separating agent, which is dissolvable in water, onto a carrier to produce a separating agent layer,

b) the simultaneous vapor-deposition of SiO_{y} and an organic separating agent, which is dissolvable in an inert organic solvent, but not in water, onto the separating agent layer (a),

c) the separation of SiO_{y} from the separating agent (a), wherein 0.70≦y≦1.95, by dissolution in water, and

(d) the dissolution of the separating agent (b) in an inert organic solvent.

The separating agent, which is dissolvable in water, is preferably an inorganic salt soluble in water and vaporisable in vacuo, such as, for example, sodium chloride, potassium chloride, lithium chloride, sodium fluoride, potassium fluoride, lithium fluoride, calcium fluoride, sodium aluminium fluoride and disodium tetraborate, or mixtures thereof.

The SiO_{y} flakes having reactive centres, i.e. at least one Si—Si group that can be cleaved, can be used to chemically bond compounds having functional groups, especially organic compounds having functional groups to the SiO_{y} flakes.

A functional group is any group, which can react with the Si—Si group to form a chemical bond: 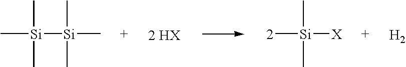
Examples of HX are listed below, but not limited thereto:
R¹OH, R¹R²C(═O), R¹R²C(═N—OH), R¹R²NOH, R¹R³NH, NHR³C(═O)R², or R¹C(═O)OH, wherein R¹ and R² are independently of each other an organic group, and R³ is hydrogen, or an organic group. 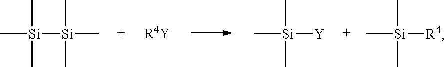
wherein Y is halogen, especially Cl, and R⁴ is an organic group.

Preferably, HX is R¹OH, especially R¹CH₂OH.

R¹CH₂OH can, for example, be derived from a polymer additive by modifying it with a CH₂OH group, or can be a polymer additive, which bears a CH₂OH group.

Such polymer additives can be selected from the group consisting of light stabilizers, heat stabilizers, metal deactivators, processing stabilizers, acid scavengers, anti-blocking agents, anti-fogging agents, antistatic agents, flame retardants, hydrophilic/hydrophobic surface modifiers, IR-reflectors, IR-absorbers, nucleating agents, scratch resistance additives and thermally conductive additives.

In addition, R¹CH₂OH can be derived from a UV absorber, especially for the protection of skin and hair, or it can be a fluorescent whitening agent.

The SiO_{y} flakes can be used to prepare photoactivatable flakes: 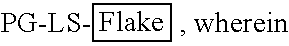
PG is a photoactivatable group,
LS is a linkage or spacer group, and 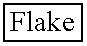
is a silicon oxide flake derived from SiO_{y} flake.

A linkage or spacer group joins the photoactivable group to the 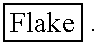
It is preferred that the linkage or spacer group includes a hydrocarbon chain, a —O—, or —NH— linkage.

Examples of the photoactivatable group are:

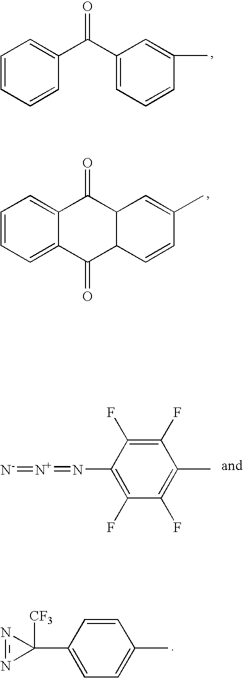

In addition, R¹CH₂OH can, for example, be derived from an organic colorant by modifying it with a CH₂OH group, or can be an organic colorant, which bears a CH₂OH group. The organic colorant can be or can be derived from a dye, or a pigment.

As an example of the different dye classes, reference may be made to the Colour Index; Colour Index, Third Edition, 1970/1971: Acid Dyes, Volume 1, pages 1001 to 1562; Basic Dyes, Volume 1, pages 1607 to 1688; Direct Dyes, Volume 2, pages 2005 to 2478; Disperse Dyes, Volume 2, pages 2479 to 2743; Natural Dyes, Volume 3, pages 3225 to 3256; Pigments, Volume 3, pages 3267 to 3390; Reactive Dyes, Volume 3, pages 3391 to 3560; Solvent Dyes, Volume 3, pages 3563 to 3648; Vat Dyes, Volume 3, pages 3719 to 3844.

The organic colorant can be derived from pigments, such as 1-aminoanthraquinone, anthraquinone, anthrapyrimidine, azo, azomethine, benzodifuranone, quinacridone, quinacridone-quinone, quinophthalone, diketopyrrolopyrrole, dioxazine, flavanthrone, indanthrone, indigo, isoindoline, isoindolinone, isoviolanthrone, perinone, perylene, phthalocyanine, pyranthrone or thioindigo. Examples of such chromophores are described, for example, in W. Herbst, K. Hunger, Industrielle Organische Pigmente, 2^{nd} completely revised edition, VCH 1995.

The organic colorant can be a fluorescent organic colorant which is, for example, selected from coumarins, benzocoumarins, xanthenes, benzo[a]xanthenes, benzo[b]xanthenes, benzo[c]xanthenes, phenoxazines, benzo[a]phenoxazines, benzo[b]phenoxazines and benzo[c]phenoxazines, napthalimides, naphtholactams, azlactones, methines, oxazines and thiazines, diketopyrrolopyrroles, perylenes, quinacridones, benzoxanthenes, thio-epindolines, lactamimides, diphenylmaleimides, acetoacetamides, imidazothiazines, benzanthrones, perylenmonoimides, perylenes, phthalimides, benzotriazoles, pyrimidines, pyrazines, and triazines.

Suitable examples are the diketopyrrolopyrroles described in WO04/009710 of the general formula: 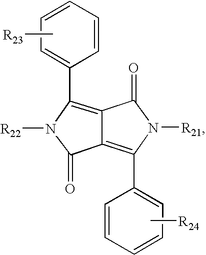
in which R₂₁ and R₂₂ are independently of one another hydrogen, C₁-C₁₈alkyl, C₁-C₁₈alkyl which is interrupted one or more times by O or S, C₇-C₁₂aralkyl or a group of the formula 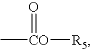
in which R₅ is C₁-C₁₈alkyl,
R₂₃ and R₂₄ independently of one another are a group of formula
—X₁—X₂—X₃, wherein
X₁ is —S—, —SO₂NH— or —NH—,
X₂ is a C₁-C₁₈alkylene group, and
X₃ is —OH; or 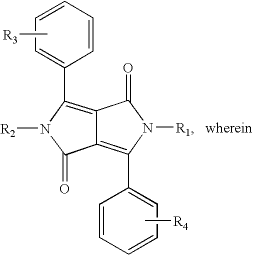
R₁ and R₂ are independently of each other a radical of the formula
—X₂—X₃, wherein
X₂ is C₁-C₁₈alkylene and
X₃ is —OH,
R₃ and R₄ independently of one another are C₁-C₁₈alkyl, C₁-C₁₈alkoxy, —NR₁₆R₁₇, —CONHR₁₈, COOR₁₉, —SO₂NH—R₂₀, C₁-C₁₈alkoxycarbonyl, C₁-C₁₈alkylaminocarbonyl, wherein R₁₆, R₁₇, R₁₈, R₁₉ and R₂₀ are C₁-C₁₈alkyl.

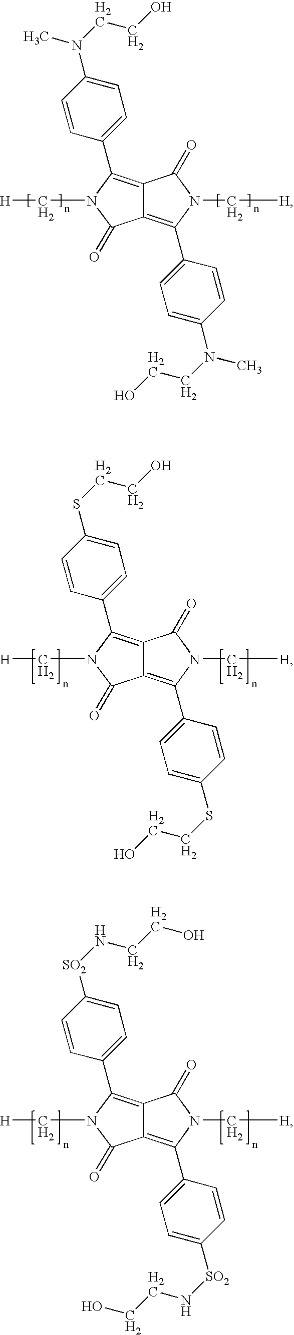

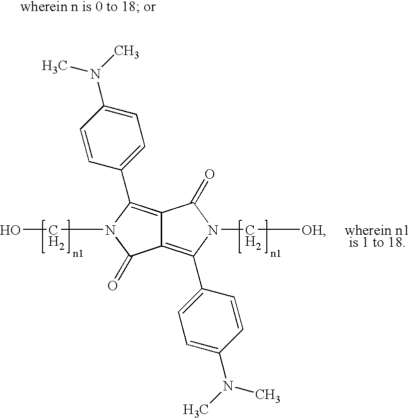

The SiO_{y} flakes can be rendered hydrophobic by reacting them with an alcohol R³⁰OH, or R³⁰Cl, wherein R³⁰ represents a substituted or unsubstituted C₁-C₂₀alkyl group. Specific examples of R³⁰ include methyl, ethyl, n-propyl, isopropyl, n-butyl, sec.-butyl, isobutyl, tert.-butyl, n-pentyl, 2-pentyl, 3-pentyl, 2,2-dimethylpropyl, n-hexyl, n-heptyl, n-octyl, 1,1,3,3-tetramethylbutyl and 2-ethylhexyl, n-nonyl, decyl, undecyl, dodecyl, tetradecyl, pentadecyl, hexadecyl, heptadecyl, octadecyl, eicosyl, heneicosyl, docosyl, tetracosyl or pentacosyl, preferably C₁-C₈alkyl such as methyl, ethyl, n-propyl, isopropyl, n-butyl, sec.-butyl, isobutyl, tert.-butyl, n-pentyl, 2-pentyl, 3-pentyl, 2,2-dimethyl-propyl, n-hexyl, n-heptyl, n-octyl, 1,1,3,3-tetramethylbutyl and 2-ethylhexyl. An example of a substituted C₁-C₂₀alkyl group is a “fluoroalkyl” group. The term “fluoroalkyl” means groups given by partially or wholly substituting the above-mentioned alkyl group with fluorine, such as trifluoromethyl, trifluoropropyl, especially 3,3,3-trifluoro-n-propyl, 2,2,2,2′,2′,2′-hexafluoroisopropyl and heptadecafluorodecyl.

In aspect of the present invention the pores of the SiO_{y} flakes can first be filled, for example, with a fluorescent dye and then be rendered hydrophobic by reacting them with an alcohol R³⁰OH.

The present invention is illustrated in more detail on the basis of the porous SiO_{y} flakes having reactive centres on their surface and in their pores, but not limited thereto. Non-porous SiO_{y} flakes having reactive centres on their surface, which can, in principal be prepared according to a process described in WO04/035693, are also suitable.

The porous SiO_{y} flakes are, in principal, obtainable by a process described in PCT/EP2004/000137. Said process comprises the steps of:

a) vapor-deposition of an organic separating agent onto a carrier to produce a separating agent layer,

b) the simultaneous vapor-deposition of SiO_{y} and the organic separating agent onto the separating agent layer (a),

c) the separation of SiO_{y} from the separating agent, wherein 0.70≦y≦1.95, by dissolution in an inert organic solvent.

The platelike porous material can be produced in a variety of distinctable and reproducible variants by changing only two process parameters: the thickness of the mixed layer of SiO_{y} and the organic separating agent and the amount of the SiO_{y} contained in the mixed layer.

The separating agent vapor-deposited onto the carrier in step a) is an organic substance soluble in organic solvents, is inert against the reactive SiO_{y} flakes and vaporisable in vacuo, such as anthracene, anthraquinone, acetamidophenol, acetylsalicylic acid, camphoric anhydride, benzimidazole, bis(4-hydroxyphenyl)sulfone, dihydroxyanthraquinone, hydantoin, phenolphthalein, phenothiazine, tetraphenylmethane, triphenylene, triphenylmethanol or a mixture of at least two of those substances.

Suitable inert solvents are, for example, ethers, in particular those having 2 to 8 carbon atoms in the molecule, such as, for example, diethyl ether, methyl ethyl ether, di-n-propyl ether, diisopropyl ether, methyl n-butyl ether, methyl tert-butyl ether, ethyl n-propyl ether, di-n-butyl ether, tetrahydrofuran, 1,4-dioxane, 1,2-dimethoxyethane, bis-β-methoxyethyl ether; aliphatic hydrocarbons, such as, for example, hexane, heptane, low- and high-boiling petroleum ethers; cycloaliphatic hydrocarbons, such as, for example, cyclohexane, methylcyclohexane, tetralin, decalin; aromatic hydrocarbons, such as, for example, benzene, toluene, o-, m- and p-xylene, ethylbenzene; nitriles, such as, for example, acetonitrile; amides, such as, for example, dimethylformamide, dimethylacetamide, N-methylpyrrolidone; hexamethylphosphoric triamide; and sulfoxides, such as, for example, dimethyl sulfoxide. Mixtures of various solvents can also be used.

In detail, an organic separating agent, for example tetraphenylmethane, followed successively by a layer of silicon suboxide (SiO_{y}) and an organic separating agent, tetraphenylmethane, is vapor-deposited onto a carrier, which may be a continuous metal belt, passing by way of the vaporisers under a vacuum of <0.5 Pa.

The mixed layer of silicon suboxide (SiO_{y}) and separating agent is vapor-deposited by two distinct vaporizers, which are each charged with one of the two materials and whose vapor beams overlap, wherein the separating agent is contained in the mixed layer in an amount of 1 to 60% by weight based on the total weight of the mixed layer.

The thicknesses of organic separating agent vapor-deposited are about 20 nm to 100 nm, especially 30 to 60 nm, those of the mixed layer from 20 to 2000 nm, especially 50 to 500 nm depending upon the intended characteristics of the product.

The carrier is immersed in a dissolution bath, i.e. an inert organic solvent, such as, for example, benzene, toluene, xylene, or a mixture thereof. With mechanical assistance, the separating agent layer rapidly dissolves and the product layer breaks up into flakes, which are then present in the solvent in the form of a suspension. The porous silicon oxide flakes can advantageously be produced using an apparatus described in U.S. Pat. No. 6,270,840.

The suspension then present in both cases, comprising product structures and solvent, and the separating agent dissolved therein, is then separated in a further operation in accordance with a known technique. For that purpose, the product structures are first concentrated in the liquid and rinsed several times with fresh solvent in order to wash out the dissolved separating agent. The product, in the form of a solid that is still wet, is then separated off by filtration, sedimentation, centrifugation, decanting or evaporation.

A SiO_{1.00-1.8} layer is formed preferably from silicon monoxide vapour produced in the vaporiser by reaction of a mixture of Si and SiO₂ at temperatures of more than 1300° C.

A SiO_{0.70-0.99} layer is formed preferably by evaporating silicon monoxide containing silicon in an amount up to 20% by weight at temperatures of more than 1300° C.

The production of porous SiO_{y} flakes with y>1 can be achieved by providing additional oxygen during the evaporation. For this purpose the vacuum chamber can be provided with a gas inlet, by which the oxygen partial pressure in the vacuum chamber can be controlled to a constant value.

After drying, the porous SiO_{y} particles can be heated according to WO03/106569 in an oxygen-free atmosphere, i.e. an argon or helium atmosphere, or in a vacuum of less than 13 Pa (10⁻¹ Torr), at a temperature above 400° C., especially 400 to 1100° C., whereby porous silicon oxide flakes containing Si nanoparticles can be obtained.

It is assumed that by heating SiO_{y} particles in an oxygen-free atmosphere, SiO_{y} disproportionates in SiO₂ and Si:
SiO_{y}→(y/y+a)SiO_{y+a}+(1−y/y+a)Si

In this disproportion porous SiO_{y+a} flakes are formed, containing (1−(y/y+a)) Si, wherein 0.70≦y≦1.8, especially 0.70≦y≦0.99 or 1≦y≦1.8, 0.05≦a≦1.30, and the sum y and a is equal or less than 2. SiO_{y+a} is an oxygen enriched silicon suboxide.
SiO_{y}→(y/2)SiO₂+(1−(y/2))Si

The porous SiO_{Z} flakes should have a minimum thickness of 50 nm, to be processible. The maximum thickness is dependent on the desired application, but is in general in the range of from 150 to 500 nm. The porosity of the flakes ranges from 5 to 85%.

The Examples that follow illustrate the invention without limiting the scope thereof. Unless otherwise indicated, percentages and parts are percentages and parts by weight, respectively.

### EXAMPLES

### Example 1

Two separate evaporators arranged in a vacuum chamber (<10⁻¹ Pa) are fed with SiO and tetraphenylmethane powder, respectively. A rotating carrier to which an aluminium foil is attached mechanically is arranged above the evaporators. A tetraphenylmethane layer (90 nm) is first sublimated onto the aluminium foil. Then the SiO evaporator is heated and the SiO begins to sublimate while tetraphenylmethane is still sublimated. In this manner tetraphenylmethane and SiO are sublimated simultaneously onto the tetraphenylmethane layer. The simultaneous vaporization of tetraphenylmethane and SiO is continued until a thickness of 300 nm is achieved. Sublimation is terminated, the aluminium foil of the carrier is removed and immersed into toluene. The tetraphenylmethane layer as well as tetraphenylmethane contained in the SiO matrix resolve in toluene, whereby silicon oxide flakes are obtained.

### Example 2

1 g SiO flakes obtained in Example 1 are suspended in a solution of 0.5 g C.I. Disperse Brown 1 of formula 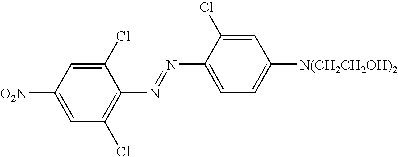
in 300 ml toluene. The suspension is heated for 48 hours under reflux, cooled to room temperature and filtered, whereby dark brown flakes are obtained.

1. A SiO_{y} flake with 0.70≦y≦1.95 comprising reactive centres.

2. The SiO_{y} flake according to claim 1, comprising [SiSi₄] components.

3. The SiO_{y} flake according to claim 1, wherein the SiO_{y} flake is non-porous and has reactive centres on its surface.

4. The SiO_{y} flake according to claim 1, wherein the SiO_{y} flake is porous and has reactive centres on its surface and in its pores, or only in its pores.

5. The SiO_{y} flake according to claim 1 which has a length of from 1 μm to 5 mm, a width of from 1 μm to 2 mm, and a thickness of from 20 nm to 1.5 μm, and a ratio of length to thickness of at least 2:1, the flake having two substantially parallel faces, the distance between which is the shortest axis of the particles.

6. A process for preparing the SiO_{y} flakes according to claim 3, comprising the steps of:
a) vapor-deposition of an organic separating agent onto a carrier to produce a separating agent layer,
b) the vapor-deposition of SiO_{y} onto the separating agent layer (a),
c) the separation of SiO_{y} from the separating agent, wherein 0.70≦y≦1.80, by dissolution in an inert organic solvent.

7. A process for preparing the SiO_{y} flakes according to claim 4, comprising the steps of:
a) vapor-deposition of an organic separating agent onto a carrier to produce a separating agent layer,
b) the simultaneous vapor-deposition of SiO_{y} and the organic separating agent onto the separating agent layer (a),
c) the separation of SiO_{y} from the separating agent, wherein 0.70≦y≦1.80, by dissolution in an inert organic solvent.

8. A process according to claim 6, wherein a separating agent, which is dissolvable in water, is deposited on the carrier before step a) and is dissolved in water before step c).

9. A process for preparing the SiO_{y} flakes according to claim 4, comprising the steps of:
a) vapor-deposition of a separating agent, which is dissolvable in water, onto a carrier to produce a separating agent layer,
b) the simultaneous vapor-deposition of SiO_{y} and an organic separating agent, which is dissolvable in an inert organic solvent, but not in water, onto the separating agent layer (a),
c) the separation of SiO_{y} from the separating agent (a), wherein 0.70≦y≦1.80, by dissolution in water, and
(d) the dissolution of the separating agent (b) in an inert organic solvent.

10-11. (canceled)

12. A process for providing chemically modified SiO_{y} flakes which process comprises reacting the SiO_{y} flake of claim 1 with a compound having functional groups that can cleave a Si—Si group, to chemically bond the compound to the SiO_{y} flakes.

13. The SiO_{y} flake according to claim 2, wherein the SiO_{y} flake is non-porous and has reactive centres on its surface.

14. The SiO_{y} flake according to claim 2, wherein the SiO_{y} flake is porous and has reactive centres on its surface and in its pores, or only in its pores.

15. The SiO_{y} flake according to claim 2 which has a length of from 1 μm to 5 mm, a width of from 1 μm to 2 mm, and a thickness of from 20 nm to 1.5 μm, and a ratio of length to thickness of at least 2:1, the flake having two substantially parallel faces, the distance between which is the shortest axis of the particles.

16. A process according to claim 6, wherein the SiO_{y} flakes that are prepared comprise [SiSi₄] components.

17. A process according to claim 7, wherein the SiO_{y} flakes that are prepared comprise [SiSi₄] components.

18. A process according to claim 7, wherein a separating agent, which is dissolvable in water, is deposited on the carrier before step a) and is dissolved in water before step c).

19. A process according to claim 7 new, wherein a separating agent, which is dissolvable in water, is deposited on the carrier before step a) and is dissolved in water before step c).

20. A process according to claim 9 for preparing the SiO_{y} flakes which comprise [SiSi₄] components.

21. A process according to claim 12, wherein the SiO_{y} flake that is reacted with a compound having functional groups that can cleave a Si—Si group comprises [SiSi₄] components.
